(19) United States
(12) Patent Application Publication
(10) Pub. No.: US 2018/0115726 A1
(43) Pub. Date: Apr. 26, 2018

(54) SOLID-STATE IMAGING DEVICE, METHOD FOR DRIVING SOLID-STATE IMAGING DEVICE, AND ELECTRONIC APPARATUS

(71) Applicant: Brillnics Inc., Grand Cayman (KY)

(72) Inventor: Norio Yoshimura, Tokyo (JP)

(73) Assignee: Brillnics Inc., Grand Cayman (KY)

(21) Appl. No.: 15/566,449

(22) PCT Filed: Apr. 13, 2016
(86) PCT No.: PCT/JP2016/061921

§ 371 Date: Oct. 13, 2017

(30) Foreign Application Priority Data
Apr. 16, 2015 (JP) 2015-084124

(51) Int. Cl. H04N 5/363; H04N 5/374; H04N 5/378

(52) U.S. Cl. CPC H04N 5/363; H04N 5/378; H04N 5/374

(57) ABSTRACT

In a solid-state imaging device, a first multiplexer array 70 is configured so that a plurality of column outputs CLM (0 to 10 . . . ) of the pixel portion 20 are formed into a plurality of groups GRP1a-1d, GRP2a-2d . . . and includes a plurality of shuffle encoders 71-0 to 71-7 . . . capable of shuffling the plurality of column outputs CLM0 to 10 . . . belonging to the groups. Further, it is configured so that, between the adjoining shuffle encoders 71, at least one column output, e.g., three column outputs, partially overlap as column outputs covered by shuffling (covered by switching)

### TECHNICAL FIELD

The present invention relates to a solid-state imaging device, a method for driving the solid-state imaging device, and an electronic apparatus performing column-parallel reading.

### BACKGROUND ART

As solid-state imaging devices (image sensors) using photoelectric conversion elements which detect light to generate electric charges, CMOS (complementary metal oxide semiconductor) image sensors have been put into practical use. CMOS image sensors are being widely applied as parts of digital cameras, video cameras, monitoring cameras, medical endoscopes, personal computers (PC), mobile phones, and other portable terminal devices (mobile devices) and various other types of electronic apparatuses.

A CMOS image sensor has a floating diffusion (FD) amplifier having, for each pixel, a photodiode (photoelectric conversion element) and floating diffusion layer. For readout, the mainstream type is the column parallel output type that selects a certain row in a pixel array and simultaneously reads the pixels out to a column output direction.

A column parallel output type CMOS image sensor basically has a pixel portion (pixel array) in which a plurality of pixels are arranged in a two-dimensional matrix state, a readout circuit which reads out pixel signals in a certain single row whose address is designated in the pixel portion to a column direction simultaneously in parallel and applies predetermined signal processing to them, and a data output circuit. In the readout circuit, an ADC and other column signal processing circuits are arranged in a column for each column. Further, column signal processing circuits of the readout circuit are arranged corresponding to the column outputs of the pixel portion.

In an image sensor having such a configuration, fixed pattern noise (FPN) caused by a difference of characteristics among the column signal processing circuits, particularly a difference of offset, is generated. This fixed pattern noise, which is fixed in space and time, tends to be easily observed due to random noise fluctuating in time.

Therefore, arts for suppressing this type of fixed pattern noise have been proposed (see for example PLT 1 and NPLT 1). In the art disclosed in PLT 1 or NPLT 1, the noise that the column signal processing circuits arranged corresponding to the column outputs of the pixel portion in the readout circuit uniquely have for each column is scattered in time and space to thereby make observation difficult by randomly switching (shuffling) the column signal processing circuits performing signal processing for each row.

### CITATION LIST

### Patent Literature

PLT1: U.S. Pat. No. 8,462,240 B2

### Nonpatent Literature

NPLT 1: M. F. Snoeij, et al., “A CMOS imager with column-level ADC using dynamic FPN reduction,” in ISSCC Dig. Tech. Papers, Paper 27.4, February 2006.

### SUMMARY OF INVENTION

### Technical Problem

However, in the art disclosed in PLT 1 explained above, any number of columns are grouped together to randomly switch (shuffle) the signal processing circuits performing signal processing for each row so as to scatter the noise that the column signal processing circuits uniquely have for each column in time and space, therefore there was tendency for a difference of the scattered noise levels between groups adjacent to each other to be emphasized.

The present invention provides a solid-state imaging device, a method for driving the solid-state imaging device, and an electronic apparatus capable of reducing a difference of noise levels between adjoining groups.

### Solution to Problem

A solid-state imaging device of a first aspect of the present invention comprises a pixel portion in which a plurality of pixels for performing photoelectric conversion are arranged in a matrix state, a readout part which is arranged corresponding to at least one column output of the pixel portion and includes a plurality of column signal processing parts for processing the input column output signals, an output part for outputting the signals processed in the plurality of column signal processing parts in the readout part, a first multiplexer which shuffles destinations of the column output signals of the column outputs of the pixel portion and can switch them so as to input the results to column signal processing parts which are different from the column signal processing parts arranged corresponding to the column outputs, and a second multiplexer which rearranges the signals processed in the plurality of column signal processing parts in the readout part so as to restore the sequence of the column outputs of the pixel portion before they were shuffled in the first multiplexer and supplies the results to the output part, wherein the first multiplexer includes a plurality of shuffle encoders in which the plurality of column outputs of the pixel portion are formed into a plurality of groups and which can shuffle the plurality of column outputs belonging to the groups, and at least between the adjoining shuffle encoders, there is at least one overlapping column output covered by shuffling.

A method for driving a solid-state imaging device of a second aspect of the present invention has a column output step of simultaneously and in parallel outputting pixel signals in a designated row in a pixel portion having a plurality of pixels for performing photoelectric conversion arranged in a matrix state therein, a first shuffle step of shuffling destinations of the column output signals of the column outputs of the pixel portion and capable of switching them so as to input the results to column signal processing parts which are different from the column signal processing parts arranged corresponding to the column outputs, a column signal processing step of performing predetermined signal processing in the plurality of column signal processing parts on the column output signals supplied by the first shuffle step, and a second shuffle step of rearranging the signals which are processed in the column signal processing step so as to restore the sequence of the column outputs of the pixel portion before they were shuffled in the first shuffle step and outputting the results to the output part, wherein, in the first shuffle step, the plurality of column outputs of the pixel portion are formed into a plurality of groups, the plurality of column outputs belonging to the groups are shuffled in the shuffle encoders corresponding to the groups, and at least between the adjoining shuffle encoders, there is at least one overlapping column output covered by shuffling.

An electronic apparatus of a third aspect of the present invention has a solid-state imaging device, an optical system for forming a subject image in the solid-state imaging device, and a signal processing part for processing output signals of the solid-state imaging device, wherein the solid-state imaging device has a pixel portion in which a plurality of pixels for performing photoelectric conversion are arranged in a matrix state, a readout part which is arranged corresponding to at least one column output of the pixel portion and includes a plurality of column signal processing parts for processing the input column output signals, an output part for outputting the signals processed in the plurality of column signal processing parts in the readout part, a first multiplexer which shuffles destinations of the column output signals of the column outputs of the pixel portion and can switch them so as to input results to column signal processing parts which are different from the column signal processing parts arranged corresponding to the column outputs, and a second multiplexer which rearranges the signals processed in the plurality of column signal processing parts in the readout part so as to restore the sequence of the column outputs of the pixel portion before they were shuffled in the first multiplexer and supplies the results to the output part, wherein the first multiplexer includes a plurality of shuffle encoders in which the plurality of column outputs of the pixel portion are formed into a plurality of groups and which can shuffle the plurality of column outputs belonging to the groups, and at least between the adjoining shuffle encoders, there is at least one overlapping column output covered by shuffling.

### Advantageous Effects of Invention

According to the present invention, a difference of noise level between adjoining groups can be reduced.

### BRIEF DESCRIPTION OF DRAWINGS

FIG. 1 is a block diagram showing an example of the configuration of a solid-state imaging device according to an embodiment of the present invention.

FIG. 2 is a block diagram more specifically showing principal parts of a readout system of column outputs of a pixel portion in the solid-state imaging device according to the embodiment of the present invention.

FIG. 3 is a circuit diagram showing an example of a pixel according to the present embodiment.

FIGS. 4A to 4C are diagrams showing an example of the configuration of a column signal processing circuit in a readout circuit according to the present embodiment.

FIG. 5 is a diagram showing an example of the configuration of a shuffle encoder of a first multiplexer array and a shuffle decoder of a second multiplexer array according to the present embodiment.

FIG. 6 is a diagram showing as a generalization an example of the configuration of the shuffle encoder in the first multiplexer where the number of column outputs to be grouped is “p”.

FIG. 7 is a diagram showing the configuration of a comparative example in which grouping is carried out, but the outputs covered by switching are not made to overlap.

FIGS. 8A and 8B are diagrams for explaining the effects of the solid-state imaging device according to the present embodiment and the effects of a comparative example.

FIGS. 9A and 9B are diagrams showing how noise is seen in the solid-state imaging devices according to the present embodiment and the comparative example.

FIGS. 10A to 10C are diagrams for explaining an example of arrangement focusing on the correspondence between the column outputs of pixels and column signal processing circuits in the solid-state imaging device according to the embodiment of the present invention.

FIG. 11 is a diagram showing an example of the configuration of an electronic apparatus to which the solid-state imaging device according to the present invention is applied.

### REFERENCE SIGNS LIST

10 . . . solid-state imaging device, 20 . . . pixel portion (PXLP), 30 . . . vertical scanning circuit (VSCN), 40 . . . timing control circuit (TMGC), 50 . . . readout circuit (RDOC), 60 . . . output circuit (OTPC), 70 . . . first multiplexer array (MPX1), 80 . . . second multiplexer array (MPX2), 100 . . . electronic apparatus, 110 . . . CMOS image sensor (IMGSNS), 120 . . . optical system, and 130 . . . signal processing circuit (PRC).

### DESCRIPTION OF EMBODIMENTS

Below, an embodiment of the present invention will be explained with reference to the drawings.

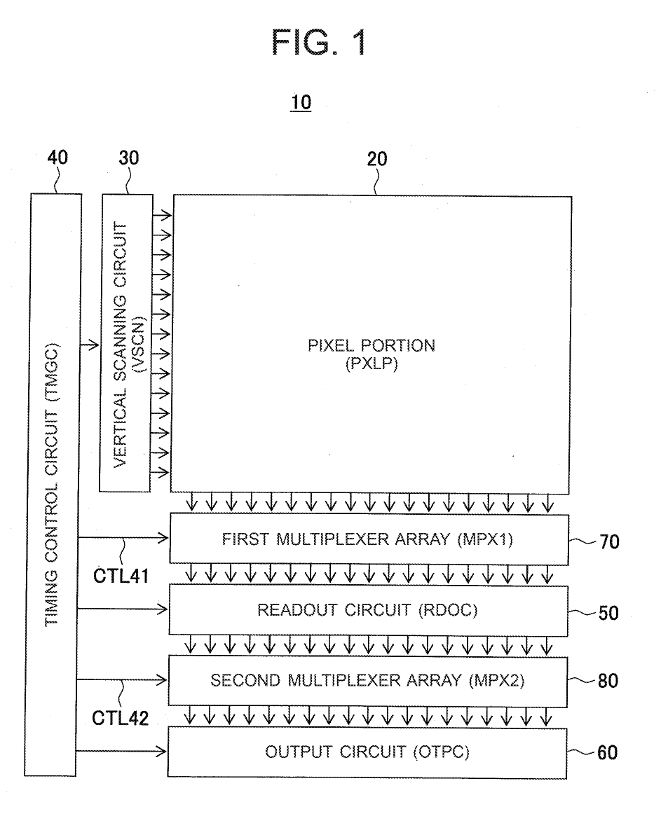

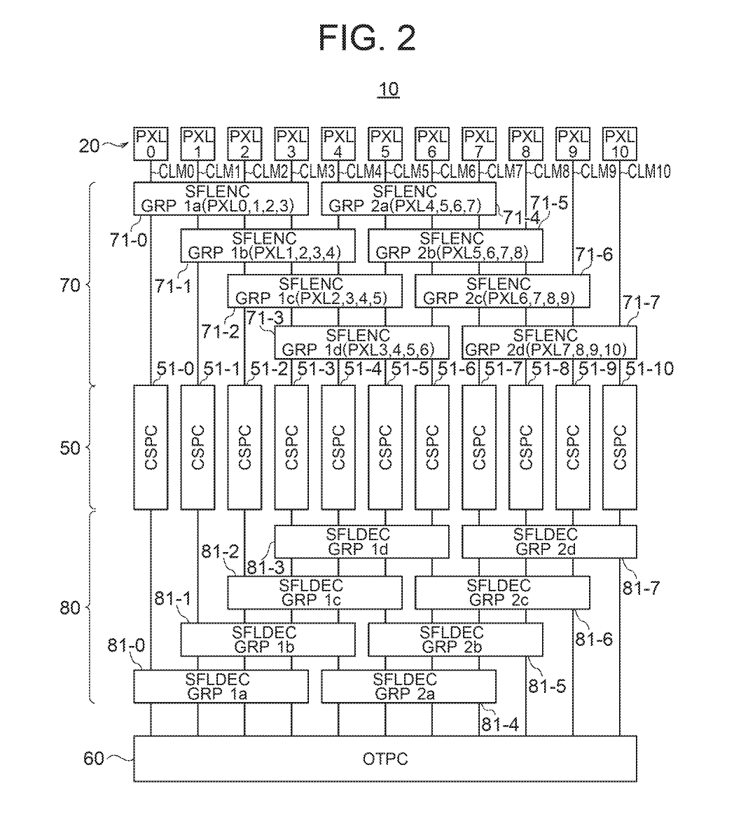

FIG. 1 is a block diagram showing an example of the configuration of a solid-state imaging device according to an embodiment of the present invention. FIG. 2 is a block diagram more specifically showing principal parts of a readout system of column outputs of a pixel portion in the solid-state imaging device according to the embodiment of the present invention. FIG. 2, for simplification of the drawing, shows only 11 column outputs of the 0-th column output CLM0 to 10th column output CLM10 as the column outputs of the pixel portion. In the present embodiment, a solid-state imaging device 10 is configured by for example a CMOS image sensor.

This solid-state imaging device 10, as shown in FIG. 1 and FIG. 2, has, as principal components, an imaging portion comprised of a pixel portion (PXLP) 20, vertical scanning (row scanning) circuit (VSCN) 30, a control part comprised of a timing control circuit (TMGC) 40, readout circuit (RDOC) 50, output circuit (OTPC) 60, first multiplexer array (MPX1) 70, and second multiplexer array (MPX2) 80.

In the pixel portion 20, a plurality of pixels including photodiodes (photoelectric conversion elements) and intra-pixel amplifiers are arranged in a two-dimensional matrix state comprised of “n” number of rows and “m” number of columns.

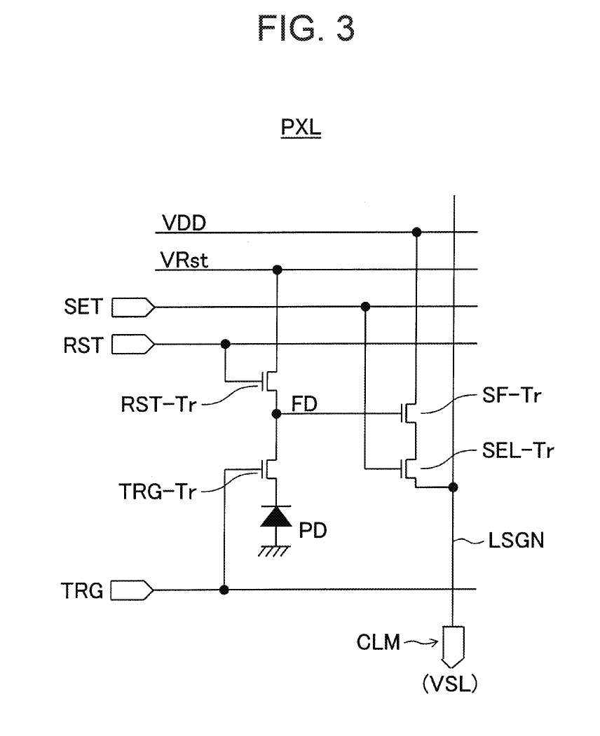

FIG. 3 is a circuit diagram showing an example of a pixel according to the present embodiment.

This pixel PXL for example has a photoelectric conversion element comprised of a photodiode (PD). Further, it has, with respect to this photodiode PD, one each of a transfer transistor TRG-Tr, reset transistor RST-Tr, source follower transistor SF-Tr, and selection transistor SEL-Tr.

The photodiode PD generates and accumulates a signal charge (here, electrons) in an amount in accordance with a quantity of incident light. Below, the case where the signal charge is comprised of electrons and each transistor is an n-type transistor will be explained, but the signal charge may also be comprised of holes and each transistor may also be a p-type transistor. Further, the present embodiment is effective even in a case where each transistor is shared among a plurality of photodiodes and even in a case where a three-transistor (3Tr) pixel not having a selection transistor is employed.

The transfer transistor TRG-Tr is connected between the photodiode PD and the floating diffusion FD (floating diffusion layer) and is controlled through a control line TRG. The transfer transistor TRG-Tr is selected and becomes the conductive state in the period when the control line TRG is a high level (H) and transfers electrons which are photoelectrically converted in the photodiode PD to the floating diffusion FD.

The reset transistor RST-Tr is connected between a power supply line VRst and the floating diffusion FD and is controlled through a control line RST. Note that, the reset transistor RST-Tr may also be configured so that it is connected between a power supply line VDD and the floating diffusion FD and is controlled through the control line RST. The reset transistor RST-Tr is selected and becomes the conductive state in the period when the control line RST is the H level and resets the floating diffusion FD to the potential of the power supply line VRst (or VDD).

The source follower transistor SF-Tr and the selection transistor SEL-Tr are connected in series between the power supply line VDD and a vertical signal line LSGN. The gate of the source follower transistor SF-Tr is connected to the floating diffusion FD. The selection transistor SEL-Tr is controlled through a control line SEL. The source follower transistor SF-Tr is connected to the column output signal line LSGN through the selection transistor SEL-Tr and configures the source follower together with a load circuit which is connected to the output signal line LSGN outside of the pixel portion 20. The selection transistor SEL-Tr is selected and becomes the conductive state in the period when the control line SEL is H. Due to this, the source follower transistor SF-Tr outputs a column output analog signal VSL in accordance with the potential of the floating diffusion FD to the column output signal line LSGN corresponding to the column output CLM. These operations are for example carried out simultaneously in parallel for each row's worth of pixels since the gates of the transfer transistors TRG-Tr, reset transistors RST-Tr, and selection transistors SEL-Tr are connected in unit of rows.

In the pixel portion 20, the pixels PXL are arranged in “n” number of rows and “m” number of columns, therefore there are “n” numbers of control lines SEL, RST, and TRG and “m” number of column output signal lines LSGN of the column outputs CLM (column output analog signals VSL). In FIG. 1, the control lines SEL, RST, and TRG are shown by single row scanning control lines.

The vertical scanning circuit 30 drives pixels through the row scanning control lines in a shutter row and readout row according to the control of the timing control circuit 40. Further, the vertical scanning circuit 30, according to address signals, outputs row selection signals of row addresses of the read row for reading of the signals and the shutter row for resetting the charges accumulated in the photodiodes PD.

The timing control circuit 40 generates timing signals which are necessary for signal processing in the pixel portion 20, vertical scanning circuit 30, readout circuit 50, output circuit 60, first multiplexer array 70, and second multiplexer array 80.

In the present embodiment, the timing control circuit 40 functions as the control part for controlling the operation in the first multiplexer array 70 of shuffling column output signals of the plurality of column outputs CLM in the pixel portion 20 and inputting the results to the column signal processing circuits (CSPC) 51-0 to 51-10 . . . (see FIG. 2) arranged for each column in the readout circuit 50 and the operation in the second multiplexer array 80 of rearranging the plurality of signals processed in units of columns in the column signal processing circuits 51-0 to 51-10 . . . in the readout circuit 50 so as to become the sequence of column outputs of the pixel portion 20 before shuffling in the first multiplexer array 70 and supplying the results to the output circuit 60. The timing control circuit 40 controls the operation in the first multiplexer array 70 according to a first control signal CTL41 and controls the operation in the second multiplexer array 80 according to a second control signal CTL42.

Here, the term “shuffle” means processing for switching at random the destination routes of column output signals of the plurality of column outputs CLM of the pixel portion 20 by shuffling circuits (shuffle encoders) and inputting the column output signals of the column outputs which are switched to either of for example the column signal processing circuits arranged for each column output inside the groups which will be explained later or outside of the groups (in the present embodiment, inside the groups as an example). By this processing, noise that the column signal processing circuits uniquely have for each column is scattered in time and space thereby making observation difficult. Further, in the present embodiment, as will be explained in detail later, the first multiplexer array 70 and second multiplexer array 80 are configured so that, by making the outputs covered by shuffling in the shuffling circuits overlap between the groups, a difference of the scattered noise level between the adjoining groups is reduced.

Note that, in the present embodiment, it is also possible to employ a configuration where the column output signals of the column outputs which are switched are input to either of for example the column signal processing circuits arranged for each column output inside the group or outside of the group as will be explained later. Due to this, it becomes possible to freely disperse noise uniquely existing for each column in the column signal processing circuit, therefore noise can be freely scattered in time and space, so it becomes possible to more effectively prevent observation.

The readout circuit 50 includes a plurality of column signal processing circuits (CSPC) 51-0 to 51-10 . . . (see FIG. 2) which are arranged corresponding to the column outputs CLM of the pixel portion 20 and is configured so that column signal processing is possible among the plurality of column signal processing circuits 51 (-0 to -10 . . . ). The readout circuit 50 applies predetermined signal processing to the column output signals of the pixel portion 20 supplied by the first multiplexer array 70 and supplies the results to the second multiplexer array 80.

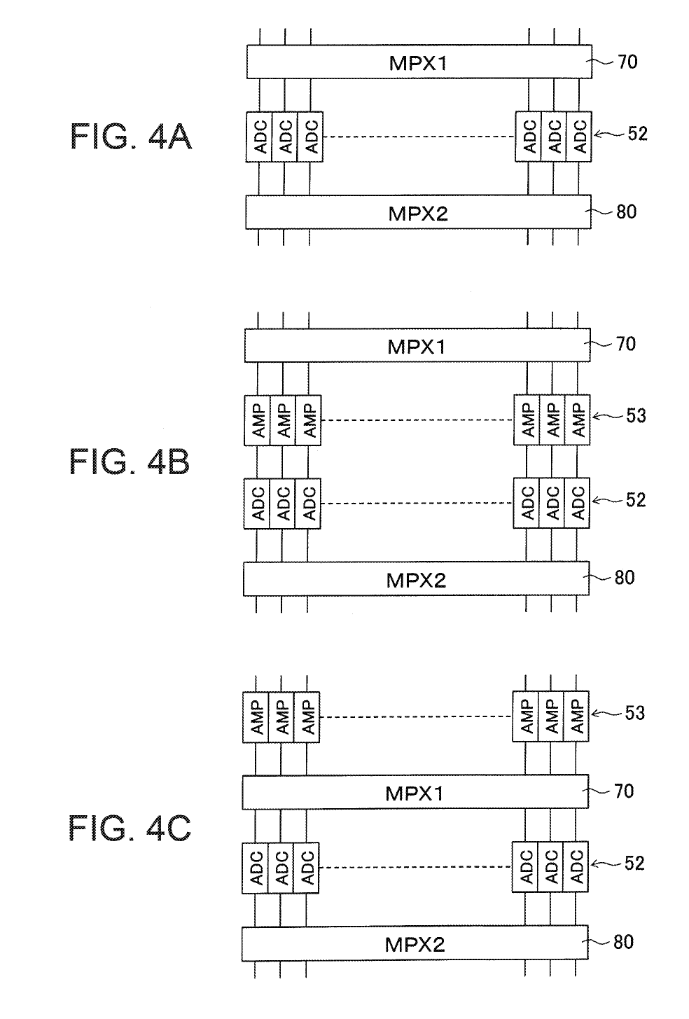

The column signal processing circuits 51 (-0 to -10 . . . ) of the readout circuit 50, for example, as shown in FIG. 4A, are configured so as to include analog-to-digital converters (ADC) 52 (-0 to -10 . . . ) converting column output analog signals VSL of the pixel portion 20 to digital signals. Further, in the column signal processing circuits 51 (-0 to -10 . . . ) of the readout circuit 50, for example, as shown in FIG. 4B, amplifiers (AMP) 53 (-0 to -10 . . . ) for amplifying the analog signals may be arranged on the input side of the ADCs 52 (-0 to -10 . . . ). Further, the arrangement positions of these amplifiers (AMP) 53 (-0 to -10 . . . ) maybe the input side of the ADCs 52 (-0 to -10 . . . ). For example, as shown in FIG. 4C, they may be arranged on the input side of the first multiplexer array 70 as well.

In the present embodiment, as an example, a configuration is shown in which the column signal processing circuits 51 (-0 to -10 . . . ) in the readout circuit 50 are arranged by a pixel pitch in a one-to-one correspondence with the column outputs CLM of the pixel portion 20. However, the column signal processing circuits which are arranged corresponding to the column outputs referred to in the present invention are not limited to configurations in which they are arranged in a one-to-one correspondence with the column outputs CLM. The column signal processing circuits 51 arranged corresponding to the column outputs mean the column signal processing circuits which are arranged so that they can regularly performing processing in the sequence of column arrangement on the column output signals of the column outputs according to the sequence of column arrangement in the pixel portion 20. The arrangement positions and arrangement method are not specified. Further, the column signal processing circuits 51 arranged corresponding to the column outputs are configured so that they can process for example the column output signals of the corresponding column outputs and the column output signals of the column outputs different from the corresponding column outputs.

The output circuit 60 outputs the signals which are supplied by the second multiplexer array 80 and are processed in the plurality of column signal processing circuits 51 in the readout circuit 50 to a not shown processing system.

The first multiplexer array 70 is configured so that it shuffles destinations of the column output signals of the column outputs CLM in the pixel portion 20 and can switch them so as to input the column output signals to the column signal processing circuits different from the column signal processing circuits arranged corresponding to the column outputs.

The first multiplexer array 70, as shown in FIG. 2, is configured so that a plurality of column outputs CLM (0 to 10 . . . ) of the pixel portion 20 are formed into a plurality of groups GRP1a-1d, GRP2a-2d . . . and includes a plurality of shuffle encoders (SFLENC) 71-0 to 71-7 . . . capable of shuffling the plurality of column outputs CLM0 to 10 . . . belonging to the groups. Further, it is configured so that, between the adjoining shuffle encoders 71, at least one column output, e.g., three column outputs in the example in FIG. 2, partially overlap as column outputs covered by shuffling (covered by switching)

In the example in FIG. 2, the grouping is carried out so that four column outputs (signals) CLM which are continuously adjacent are classified into one group. As explained above, between the adjoining shuffle encoders 71, three column outputs overlap as outputs covered by shuffling, therefore the grouping is specifically carried out as follows.

The group GRP1a is formed by classifying the four column outputs CLM0, CLM1, CLM2, and CLM3 into one group. The shuffle encoder 71-0 shuffles the four column outputs CLM0, CLM1, CLM2, and CLM3 in this group GRP1a.

In the present embodiment, as an example, under the control of the timing control circuit 40, the shuffle encoder 71-0 selects one among the 0-th column output CLM0, first column output CLM1, second column output CLM2, and third column output CLM3 of the pixel portion 20 and inputs the selected column output signal to the column signal processing circuit 51-0 arranged in the 0-th column in the readout circuit 50 arranged so as to correspond to the 0-th column output CLM0 of the pixel portion 20.

The group GRP1b is formed by classifying the four column outputs CLM1, CLM2, CLM3, and CLM4 into one group. The shuffle encoder 71-1 shuffles the four column outputs CLM1, CLM2, CLM3, and CLM4 in this group GRP1b. Among the four outputs covered by shuffling of this shuffle encoder 71-1, three column outputs CLM1, CLM2, and CLM3 overlap those of the adjacent shuffle encoder 71-0.

In the present embodiment, as an example, under the control of the timing control circuit 40, the shuffle encoder 71-1 selects one among the first column output CLM1, second column output CLM2, third column output CLM3, and fourth column output CLM4 of the pixel portion 20 and inputs the selected column output signal to the column signal processing circuit 51-1 arranged in the first column in the readout circuit 50 arranged so as to correspond to the first column output CLM1 of the pixel portion 20.

The group GRP1c is formed by classifying the four column outputs CLM2, CLM3, CLM4, and CLM5 into one group. The shuffle encoder 71-2 shuffles the four column outputs CLM2, CLM3, CLM4, and CLM5 in this group GRP1c. Among the four outputs covered by shuffling of this shuffle encoder 71-2, three column outputs CLM2, CLM3, and CLM4 overlap those of the adjacent shuffle encoder 71-1.

In the present embodiment, as an example, under the control of the timing control circuit 40, the shuffle encoder 71-2 selects one among the second column output CLM2, third column output CLM3, fourth column output CLM4, and fifth column output CLM5 of the pixel portion 20 and inputs the selected column output signal to the column signal processing circuit 51-2 arranged in the second column in the readout circuit 50 arranged so as to correspond to the second column output CLM2 of the pixel portion 20.

The group GRP1d is grouped by classifying the four column outputs CLM3, CLM4, CLM5, and CLM6 into one group. The shuffle encoder 71-3 shuffles the four column outputs CLM3, CLM4, CLM5, and CLM6 in this group GRP1d. Among the four outputs covered by shuffling of this shuffle encoder 71-3, three column outputs CLM3, CLM4, and CLM5 overlap those of the adjacent shuffle encoder 71-2.

In the present embodiment, as an example, under the control of the timing control circuit 40, the shuffle encoder 71-3 selects one among the third column output CLM3, fourth column output CLM4, fifth column output CLM5, and sixth column output CLM6 of the pixel portion 20 and inputs the selected column output signal to the column signal processing circuit 51-3 arranged in the third column in the readout circuit 50 arranged so as to correspond to the third column output CLM3 of the pixel portion 20.

The group GRP2a is formed by classifying the four column outputs CLM4, CLM5, CLM6, and CLM7 into one group. The shuffle encoder 71-4 shuffles the four column outputs CLM4, CLM5, CLM6, and CLM7 in this group GRP2a. Among the four outputs covered by shuffling of this shuffle encoder 71-4, three column outputs CLM4, CLM5, and CLM6 overlap those of the adjacent shuffle encoder 71-3.

In the present embodiment, as an example, under the control of the timing control circuit 40, the shuffle encoder 71-4 selects one among the fourth column output CLM4, fifth column output CLM5, sixth column output CLM6, and seventh column output CLM7 of the pixel portion 20 and inputs the selected column output signal to the column signal processing circuit 51-4 arranged in the fourth column in the readout circuit 50 arranged so as to correspond to the fourth column output CLM4 of the pixel portion 20.

The group GRP2b is formed by classifying the four column outputs CLM5, CLM6, CLM7, and CLM8 into one group. The shuffle encoder 71-5 shuffles the four column outputs CLM5, CLM6, CLM7, and CLM8 in this group GRP2b. Among the four outputs covered by shuffling of this shuffle encoder 71-5, three column outputs CLM5, CLM6, and CLM7 overlap those of the adjacent shuffle encoder 71-4.

In the present embodiment, as an example, under the control of the timing control circuit 40, the shuffle encoder 71-5 selects one among the fifth column output CLM5, sixth column output CLM6, seventh column output CLM7, and eighth column output CLM8 of the pixel portion 20 and inputs the selected column output signal to the column signal processing circuit 51-5 arranged in the fifth column in the readout circuit 50 arranged so as to correspond to the fifth column output CLM5 of the pixel portion 20.

The group GRP2c is formed by classifying the four column outputs CLM6, CLM7, CLM8, and CLM9 into one group. The shuffle encoder 71-6 shuffles the four column outputs CLM6, CLM7, CLM8, and CLM9 in this group GRP2c. Among the four outputs covered by shuffling of this shuffle encoder 71-6, three column outputs CLM6, CLM7, and CLM8 overlap those of the adjacent shuffle encoder 71-5.

In the present embodiment, as an example, under the control of the timing control circuit 40, the shuffle encoder 71-6 selects one among the sixth column output CLM6, seventh column output CLM7, eighth column output CLM8, and ninth column output CLM9 of the pixel portion 20 and inputs the selected column output signal to the column signal processing circuit 51-6 arranged in the sixth column in the readout circuit 50 arranged so as to correspond to the sixth column output CLM6 of the pixel portion 20.

The group GRP2d is formed by classifying the four column outputs CLM7, CLM8, CLM9, and CLM10 into one group. The shuffle encoder 71-7 shuffles the four column outputs CLM7, CLM8, CLM9, and CLM10 in this group GRP2d. Among the four outputs covered by shuffling of this shuffle encoder 71-7, three column outputs CLM7, CLM8, and CLM9 overlap those of the adjacent shuffle encoder 71-6.

In the present embodiment, as an example, under the control of the timing control circuit 40, the shuffle encoder 71-7 selects one among the seventh column output CLM7, eighth column output CLM8, ninth column output CLM9, and 10th column output CLM10 of the pixel portion 20 and inputs the selected column output signal to the column signal processing circuit 51-7 arranged in the seventh column in the readout circuit 50 arranged so as to correspond to the seventh column output CLM7 of the pixel portion 20.

As described above, in the present embodiment, the shuffle encoder 71-0 shuffles the reference column output CLM0 of the group GRP1a to which it belongs and the plurality of column outputs CLM1, CLM2, and CLM3 which are successively adjacent to the reference column output. It inputs one shuffled column output signal to one column signal processing circuit 51 in the readout circuit 50, for example, the column signal processing circuit 51-0 arranged corresponding to the reference column output CLM0. Further, the plurality of column outputs CLM1, CLM2, and CLM3 which are successively adjacent to the reference column output CLM0 become the reference column outputs of the other shuffle encoders 71-1, 71-2, and 71-3. That is, for example, the adjacent column output CLM1 among the plurality of column outputs which are successively adjacent to the reference column output CLM0 is the reference column output of the adjacent shuffle encoder 71-1.

Here, “the reference column output” means, among the plurality of column outputs to be shuffled belonging to the group, a column output in the group that can input the column output signal after shuffling to the column signal processing circuit which is arranged corresponding to the column output. For example, as explained above, in the group GRP1a, among the plurality of column outputs CLM0, CLM1, CLM2, and CLM3 to be shuffled belonging to the group, it means the column output CLM0 capable of inputting the column output signal after shuffling to the column signal processing circuit 51-0 which is arranged corresponding to the column output. Note that, in this example, among the plurality of column outputs CLM0, CLM1, CLM2, and CLM3 to be shuffled belonging to the group, the column outputs CLM1, CLM2, and CLM3 correspond to “other” column outputs other than the reference column output CLM0. Below, the reference column output is defined in the same way in the other groups. Accordingly, in the following, the description of this will be omitted.

The shuffle encoder 71-1 shuffles the reference column output CLM1 of the group GRP1b to which it belongs and the plurality of column outputs CLM2, CLM3, and CLM4 which are successively adjacent to the reference column output and inputs one shuffled column output signal to one column signal processing circuit 51 in the readout circuit 50, for example, the column signal processing circuit 51-1 arranged corresponding to the reference column output CLM1. Further, the plurality of column outputs CLM2, CLM3, and CLM4 which are successively adjacent to the reference column output CLM1 become the reference column outputs of the other shuffle encoders 71-2, 71-3, and 71-4. That is, for example, the adjacent column output CLM2 among the plurality of column outputs which are successively adjacent to the reference column output CLM1 becomes the reference column output of the adjacent shuffle encoder 71-2.

The shuffle encoder 71-2 shuffles the reference column output CLM2 of the group GRP1c to which it belongs and the plurality of column outputs CLM3, CLM4, and CLM5 which are successively adjacent to the reference column output and inputs one shuffled column output signal to one column signal processing circuit 51 in the readout circuit 50, for example column signal processing circuit 51-2 arranged corresponding to the reference column output CLM2. Further, the plurality of column outputs CLM3, CLM4, and CLM5 which are successively adjacent to the reference column output CLM2 become reference column outputs of the other shuffle encoders 71-3, 71-4, and 71-5. That is, for example, the adjacent column output CLM3 among the plurality of column outputs which are successively adjacent to the reference column output CLM2 becomes the reference column output of the adjacent shuffle encoder 71-3.

The shuffle encoder 71-3 shuffles the reference column output CLM3 of the group GRP1d to which it belongs and the plurality of column outputs CLM4, CLM5, and CLM6 which are successively adjacent to the reference column output and inputs one shuffled column output signal to one column signal processing circuit 51 in the readout circuit 50, for example, the column signal processing circuit 51-3 arranged corresponding to the reference column output CLM3. Further, the plurality of column outputs CLM4, CLM5, and CLM6 which are successively adjacent to the reference column output CLM3 become the reference column outputs of the other shuffle encoders 71-4, 71-5, and 71-6. That is, for example, the adjacent column output CLM4 among the plurality of column outputs which are successively adjacent to the reference column output CLM3 becomes the reference column output of the adjacent shuffle encoder 71-4.

In the same way, the shuffle encoder 71-4 shuffles the reference column output CLM4 of the group GRP2a to which it belongs and the plurality of column outputs CLM5, CLM66, and CLM7 which are successively adjacent to the reference column output and inputs one shuffled column output signal to one column signal processing circuit 51 in the readout circuit 50, for example, the column signal processing circuit 51-4 arranged corresponding to the reference column output CLM4. Further, the plurality of column outputs CLM5, CLM6, and CLM7 which are successively adjacent to the reference column output CLM4 become the reference column outputs of the other shuffle encoders 71-5, 71-6, and 71-7. That is, for example, the adjacent column output CLM5 among the plurality of column outputs which are successively adjacent to the reference column output CLM4 becomes the reference column output of the adjacent shuffle encoder 71-5.

The shuffle encoder 71-5 shuffles the reference column output CLM5 of the group GRP2b to which it belongs and the plurality of column outputs CLM6, CLM7, and CLM8 which are successively adjacent to the reference column output and inputs one shuffled column output signal to one column signal processing circuit 51 in the readout circuit 50, for example, the column signal processing circuit 51-5 arranged corresponding to the reference column, output CLM5. Further, the plurality of column outputs CLM6, CLM7, and CLM8 which are successively adjacent to the reference column output CLM5 become reference column outputs of the other shuffle encoders 71-6, 71-7, and 71-8. That is, for example, the adjacent column output CLM6 among the plurality of column outputs which are successively adjacent to the reference column output CLM5 becomes the reference column output of the adjacent shuffle encoder 71-6.

The shuffle encoder 71-6 shuffles the reference column output CLM6 of the group GRP2c to which it belongs and the plurality of column outputs CLM7, CLM8, and CLM9 which are successively adjacent to the reference column output and inputs one shuffled column output signal to one column signal processing circuit 51 in the readout circuit 50, for example, the column signal processing circuit 51-6 arranged corresponding to the reference column output CLM6. Further, the plurality of column outputs CLM7, CLM8, and CLM9 which are successively adjacent to the reference column output CLM6 become reference column outputs of the other shuffle encoders 71-7, 71-8, and 71-9. That is, for example, the adjacent column output CLM7 among the plurality of column outputs which are successively adjacent to the reference column output CLM6 becomes the reference column output of the adjacent shuffle encoder 71-7.

The shuffle encoder 71-7 shuffles the reference column output CLM7 of the group GRP2d to which it belongs and the plurality of column outputs CLM8, CLM9, and CLM10 which are successively adjacent to the reference column output and inputs one shuffled column output signal to one column signal processing circuit 51 in the readout circuit 50, for example, the column signal processing circuit 51-7 arranged corresponding to the reference column output CLM7. Further, the plurality of column outputs CLM8, CLM9, and CLM10 which are successively adjacent to the reference column output CLM7 become the reference column outputs of the other shuffle encoders 71-8, 71-9, and 71-10. That is, for example, the adjacent column output CLM8 among the plurality of column outputs which are successively adjacent to the reference column output CLM7 becomes the reference column output of the adjacent shuffle encoder 71-8 (not shown).

The second multiplexer array 80 rearranges the signals processed in the plurality of column signal processing circuits 51 (-0 to -7 . . . ) in the readout circuit 50 to become the sequence of the column outputs of the pixel portion 20 before shuffling in the first multiplexer array 70 and supplies the results to the output circuit 60.

The second multiplexer array 80 is configured to include a plurality of shuffle decoders (SFLDEC) 81-0 to 81-7 . . . which are arranged corresponding to the plurality of shuffle encoders 71 (-0 to -7 . . . ) in the first multiplexer array 70. The shuffle decoders 81 (-0 to -7 . . . ) rearrange the signals processed in the plurality of column signal processing circuits 51 (-0 to -7 . . . ) in the readout circuit 50 so as to become the sequence of the column outputs of the pixel portion 20 before shuffling in the shuffle encoders 71 (-0 to -7 . . . ) in the first multiplexer array 70 and supplies the results to the output circuit 60.

The second multiplexer array 80 is provided with a shuffle decoder 81-0 corresponding to the shuffle encoder 71-0 in charge of the shuffle operation of the group GRP1a in the first multiplexer array 70. The shuffle decoder 81-0 performs rearrangement so that the four column outputs (signals) CLM0, CLM1, CLM2, and CLM3 of the pixel portion 20 which are shuffled in the shuffle encoder 71-0 are restored to the sequence CLM0, CLM1, CLM2, and CLM3 of the column outputs of the pixel portion 20 before shuffling upon receipt of the processed signals which are subjected to AD conversion and other predetermined signal processing in the column signal processing circuit 51-0 in the readout circuit 50 and supplies the results to the output circuit 60.

For example, when the signal of the column output CLM1 is processed in the column signal processing circuit 51-0 in the 0-th column, the shuffle decoder 81-0 supplies the output signal thereof as the output of the column signal processing circuit 51-1 in the first column to the output circuit 60. When the signal of the column output CLM2 is processed in the column signal processing circuit 51-0 in the 0-th column, the shuffle decoder 81-0 supplies the output signal thereof as the output of the column signal processing circuit 51-2 in the second column to the output circuit 60. When the signal of the column output CLM3 is processed in the column signal processing circuit 51-0 in the 0-th column, the shuffle decoder 81-0 supplies the output signal thereof as the output of the column signal processing circuit 51-3 in the third column to the output circuit 60. When the signal of the column output CLM0 is processed in the column signal processing circuit 51-0 in the 0-th column, the shuffle decoder 81-0 supplies the output signal thereof as it is as the output of the column signal processing circuit 51-0 in the 0-th column to the output circuit 60.

In the second multiplexer array 80, the shuffle decoder 81-1 is provided corresponding to the shuffle encoder 71-1 in charge of the shuffle operation of the group GRP1b in the first multiplexer array 70. The shuffle decoder 81-1 performs rearrangement so that the four column outputs (signals) CLM1, CLM2, CLM3, and CLM4 of the pixel portion 20 which are shuffled in the shuffle encoder 71-1 are restored to the sequence CLM1, CLM2, CLM3, and CLM4 of the column outputs of the pixel portion 20 before shuffling upon receipt of the processed signals which were subjected to AD conversion and other predetermined signal processing in the column signal processing circuit 51-1 in the readout circuit 50 and supplies the results to the output circuit 60.

For example, when the signal of the column output CLM2 is processed in the column signal processing circuit 51-1 in the first column, the shuffle decoder 81-1 supplies the output signal thereof as the output of the column signal processing circuit 51-2 in the second column to the output circuit 60. When the signal of the column output CLM3 is processed in the column signal processing circuit 51-1 in the first column, the shuffle decoder 81-1 supplies the output signal thereof as the output of the column signal processing circuit 51-3 in the third column to the output circuit 60. When the signal of the column output CLM4 is processed in the column signal processing circuit 51-1 in the first column, the shuffle decoder 81-1 supplies the output signal thereof as the output of the column signal processing circuit 51-4 in the fourth column to the output circuit 60. When the signal of the column output CLM1 is processed in the column signal processing circuit 51-1 in the first column, the shuffle decoder 81-1 supplies the output signal thereof as it is as the output of the column signal processing circuit 51-1 in the first column to the output circuit 60.

In the second multiplexer array 80, the shuffle decoder 81-2 is provided corresponding to the shuffle encoder 71-2 in charge of the shuffle operation of the group GRP1c in the first multiplexer array 70. The shuffle decoder 81-2 performs rearrangement so that the four column outputs (signals) CLM2, CLM3, CLM4, and CLM5 of the pixel portion 20 which are shuffled in the shuffle encoder 71-2 are restored to the sequence CLM2, CLM3, CLM4, and CLM5 of the column outputs of the pixel portion 20 before shuffling upon receipt of the processed signals which were subjected to AD conversion and other predetermined signal processing in the column signal processing circuit 51-2 in the readout circuit 50 and supplies the results to the output circuit 60.

For example, when the signal of the column output CLM3 is processed in the column signal processing circuit 51-2 in the second column, the shuffle decoder 81-2 supplies the output signal thereof as the output of the column signal processing circuit 51-3 in the third column to the output circuit 60. When the signal of the column output CLM4 is processed in the column signal processing circuit 51-2 in the second column, the shuffle decoder 81-2 supplies the output signal thereof as the output of the column signal processing circuit 51-4 in the fourth column to the output circuit 60. When the signal of the column output CLM5 is processed in the column signal processing circuit 51-2 in the second column, the shuffle decoder 81-2 supplies the output signal thereof as the output of the column signal processing circuit 51-5 in the fifth column to the output circuit 60. When the signal of the column output CLM2 is processed in the column signal processing circuit 51-2 in the second column, the shuffle decoder 81-2 supplies the output signal thereof as it is as the output of the column signal processing circuit 51-2 in the second column to the output circuit 60.

In the second multiplexer array 80, the shuffle decoder 81-3 is provided corresponding to the shuffle encoder 71-3 in charge of the shuffle operation of the group GRP1d in the first multiplexer array 70. The shuffle decoder 81-3 performs rearrangement so that the four column outputs (signals) CLM3, CLM4, CLM5, and CLM6 of the pixel portion 20 which are shuffled in the shuffle encoder 71-3 are restored to the sequence CLM3, CLM4, CLM5, and CLM6 of the column outputs of the pixel portion 20 before shuffling upon receipt of the processed signals which were subjected to AD conversion and other predetermined signal processing in the column signal processing circuit 51-3 in the readout circuit 50 and supplies the results to the output circuit 60.

For example, when the signal of the column output CLM4 is processed in the column signal processing circuit 51-3 in the third column, the shuffle decoder 81-3 supplies the output signal thereof as the output of the column signal processing circuit 51-4 in the fourth column to the output circuit 60. When the signal of the column output CLM5 is processed in the column signal processing circuit 51-3 in the third column, the shuffle decoder 81-3 supplies the output signal thereof as the output of the column signal processing circuit 51-5 in the fifth column to the output circuit 60. When the signal of the column output CLM6 is processed in the column signal processing circuit 51-3 in the third column, the shuffle decoder 81-3 supplies the output signal thereof as the output of the column signal processing circuit 51-6 in the sixth column to the output circuit 60. When the signal of the column output CLM3 is processed in the column signal processing circuit 51-3 in the third column, the shuffle decoder 81-3 supplies the output signal thereof as it is as the output of the column signal processing circuit 51-3 in the third column to the output circuit 60.

In the second multiplexer array 80, the shuffle decoder 81-4 is provided corresponding to the shuffle encoder 71-4 in charge of the shuffle operation of the group GRP2a in the first multiplexer array 70. The shuffle decoder 81-4 performs rearrangement so that the four column outputs (signals) CLM4, CLM5, CLM6, and CLM7 of the pixel portion 20 which are shuffled in the shuffle encoder 71-4 are restored to the sequence CLM4, CLM5, CLM6, and CLM7 of the column outputs of the pixel portion 20 before shuffling upon receipt of the processed signals which were subjected to AD conversion and other predetermined signal processing in the column signal processing circuit 51-4 in the readout circuit 50 and supplies the results to the output circuit 60.

For example, when the signal of the column output CLM5 is processed in the column signal processing circuit 51-4 in the fourth column, the shuffle decoder 81-4 supplies the output signal thereof as the output of the column signal processing circuit 51-5 in the fifth column to the output circuit 60. When the signal of the column output CLM6 is processed in the column signal processing circuit 51-4 in the fourth column, the shuffle decoder 81-4 supplies the output signal thereof as the output of the column signal processing circuit 51-6 in the sixth column to the output circuit 60. When the signal of the column output CLM7 is processed in the column signal processing circuit 51-4 in the fourth column, the shuffle decoder 81-4 supplies the output signal thereof as the output of the column signal processing circuit 51-7 in the seventh column to the output circuit 60. When the signal of the column output CLM4 is processed in the column signal processing circuit 51-4 in the fourth column, the shuffle decoder 81-4 supplies the output signal thereof as it is as the output of the column signal processing circuit 51-4 in the fourth column to the output circuit 60.

In the second multiplexer array 80, the shuffle decoder 81-5 is provided corresponding to the shuffle encoder 71-5 in charge of the shuffle operation of the group GRP2b in the first multiplexer array 70. The shuffle decoder 81-5 performs rearrangement so that the four column outputs (signals) CLM5, CLM6, CLM7, and CLM8 of the pixel portion 20 which are shuffled in the shuffle encoder 71-5 are restored to the sequence CLM5, CLM6, CLM7, and CLM8 of the column outputs of the pixel portion 20 before shuffling upon receipt of the processed signals which were subjected to AD conversion and other predetermined signal processing in the column signal processing circuit 51-5 in the readout circuit 50 and supplies the results to the output circuit 60.

For example, when the signal of the column output CLM6 is processed in the column signal processing circuit 51-5 in the fifth column, the shuffle decoder 81-5 supplies the output signal thereof as the output of the column signal processing circuit 51-6 in the sixth column to the output circuit 60. When the signal of the column output CLM7 is processed in the column signal processing circuit 51-5 in the fifth column, the shuffle decoder 81-5 supplies the output signal thereof as the output of the column signal processing circuit 51-7 in the seventh column to the output circuit 60. When the signal of the column output CLM8 is processed in the column signal processing circuit 51-5 in the fifth column, the shuffle decoder 81-5 supplies the output signal thereof as the output of the column signal processing circuit 51-8 in the eighth column to the output circuit 60. When the signal of the column output CLM5 is processed in the column signal processing circuit 51-5 in the fifth column, the shuffle decoder 81-5 supplies the output signal thereof as it is as the output of the column signal processing circuit 51-5 in the fifth column to the output circuit 60.

In the second multiplexer array 80, the shuffle decoder 81-6 is provided corresponding to the shuffle encoder 71-6 in charge of the shuffle operation of the group GRP2c in the first multiplexer array 70. The shuffle decoder 81-6 performs rearrangement so that the four column outputs (signals) CLM6, CLM7, CLM8, and CLM9 of the pixel portion 20 which are shuffled in the shuffle encoder 71-6 are restored to the sequence CLM6, CLM7, CLM8, and CLM9 of the column outputs of the pixel portion 20 before shuffling upon receipt of the processed signals which were subjected to AD conversion and other predetermined signal processing in the column signal processing circuit 51-6 in the readout circuit 50 and supplies the results to the output circuit 60.

For example, when the signal of the column output CLM7 is processed in the column signal processing circuit 51-6 in the sixth column, the shuffle decoder 81-6 supplies the output signal thereof as the output of the column signal processing circuit 51-7 in the seventh column to the output circuit 60. When the signal of the column output CLM8 is processed in the column signal processing circuit 51-6 in the sixth column, the shuffle decoder 81-6 supplies the output signal thereof as the output of the column signal processing circuit 51-8 in the eighth column to the output circuit 60. When the signal of the column output CLM9 is processed in the column signal processing circuit 51-6 in the sixth column, the shuffle decoder 81-6 supplies the output signal thereof as the output of the column signal processing circuit 51-9 in the ninth column to the output circuit 60. When the signal of the column output CLM6 is processed in the column signal processing circuit 51-6 in the sixth column, the shuffle decoder 81-6 supplies the output signal thereof as it is as the output of the column signal processing circuit 51-6 in the sixth column to the output circuit 60.

In the second multiplexer array 80, the shuffle decoder 81-7 is provided corresponding to the shuffle encoder 71-7 in charge of the shuffle operation of the group GRP2d in the first multiplexer array 70. The shuffle decoder 81-7 performs rearrangement so that the four column outputs (signals) CLM7, CLM8, CLM9, and CLM10 of the pixel portion 20 which are shuffled in the shuffle encoder 71-7 are restored to the sequence CLM7, CLM8, CLM9, and CLM10 of the column outputs of the pixel portion 20 before shuffling upon receipt of the processed signals which were subjected to AD conversion and other predetermined signal processing in the column signal processing circuit 51-7 in the readout circuit 50 and supplies the results to the output circuit 60.

For example, when the signal of the column output CLM8 is processed in the column signal processing circuit 51-7 in the seventh column, the shuffle decoder 81-7 supplies the output signal thereof as the output of the column signal processing circuit 51-8 in the eighth column to the output circuit 60. When the signal of the column output CLM9 is processed in the column signal processing circuit 51-7 in the seventh column, the shuffle decoder 81-7 supplies the output signal thereof as the output of the column signal processing circuit 51-9 in the ninth column to the output circuit 60. When the signal of the column output CLM10 is processed in the column signal processing circuit 51-7 in the seventh column, the shuffle decoder 81-7 supplies the output signal thereof as the output of the column signal processing circuit 51-10 in the 10th column to the output circuit 60. When the signal of the column output CLM7 is processed in the column signal processing circuit 51-7 in the seventh column, the shuffle decoder 81-7 supplies the output signal thereof as it is as the output of the column signal processing circuit 51-7 in the seventh column to the output circuit 60.

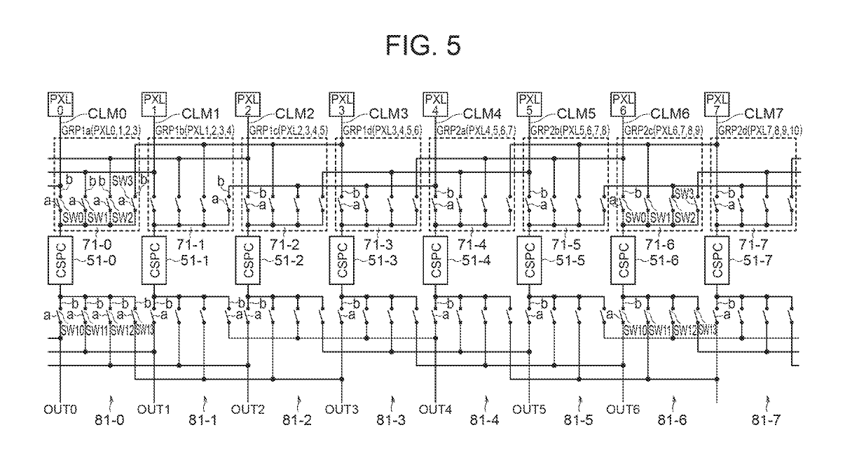

Here, an explanation will be given of an example of the configuration for realizing the shuffle encoders in the first multiplexer array and the shuffle decoders in the second multiplexer array having the above configurations and functions. FIG. 5 is a diagram showing an example of the configuration of the shuffle encoders in the first multiplexer array and the shuffle decoders in the second multiplexer array according to the present embodiment.

The shuffle encoders 71-0 to 71-7 . . . in the first multiplexer array 70 are configured so that each includes four on/off switches SW since the number of the column outputs which are grouped in the present embodiment is four. In the same way, the shuffle decoders 81-0 to 81-7 . . . in the second multiplexer array 80 are configured so that each includes four on/off switches SW. Each of the shuffle encoders 71-0 to 71-7 has switches SW0 to SW3. Each of the shuffle decoders 81-0 to 81-7 has switches SW10 to SW13 as well. Between the shuffle encoder 71 and the shuffle decoder 81 in the corresponding groups, the switches SW0 and SW10, the switches SW1 and SW11, the switches SW2 and SW12, and the switches SW3 and SW13 form pairs and are turned on/off simultaneously in parallel.

In the shuffle encoder 71-0, the terminals “a” of the switches SW0 to SW3 are connected to the input of the column signal processing circuit 51-0 arranged in the 0-th column. The terminal “b” of the switch SW0 is connected to the 0-th column output CLM0, the terminal “b” of the switch SW1 is connected to the first column output CLM1, the terminal “b” of the switch SW2 is connected to the second column output CLM2, and the terminal “b” of the switch SW3 is connected to the third column output CLM3. In the shuffle encoder 71-0, the switches SW0 to SW3 are switched at random and either of the signals of the column outputs CLM0 to CLM3 of the pixel portion 20 is input to the column signal processing circuit 51-0 in the 0-th column.

In the shuffle encoder 71-1, the terminals “a” of the switches SW0 to SW3 are connected to the input of the column signal processing circuit 51-1 arranged in the first column. The terminal “b” of the switch SW0 is connected to the first column output CLM1, the terminal “b” of the switch SW1 is connected to the second column output CLM2, the terminal “b” of the switch SW2 is connected to the third column output CLM3, and the terminal “b” of the switch SW3 is connected to the fourth column output CLM4. In the shuffle encoder 71-1, the switches SW0 to SW3 are switched at random and either of the signals of the column outputs CLM1 to CLM4 of the pixel portion 20 is input to the column signal processing circuit 51-1 in the first column.

In the shuffle encoder 71-2, the terminals “a” of the switches SW0 to SW3 are connected to the input of the column signal processing circuit 51-2 arranged in the second column. The terminal “b” of the switch SW0 is connected to the second column output CLM2, the terminal “b” of the switch SW1 is connected to the third column output CLM3, the terminal “b” of the switch SW2 is connected to the fourth column output CLM4, and the terminal “b” of the switch SW3 is connected to the fifth column output CLM5. In the shuffle encoder 71-2, the switches SW0 to SW3 are switched at random and either of the signals of the column outputs CLM2 to CLM5 of the pixel portion 20 is input to the column signal processing circuit 51-2 in the second column.

In the shuffle encoder 71-3, the terminals “a” of the switches SW0 to SW3 are connected to the input of the column signal processing circuit 51-3 arranged in the third column. The terminal “b” of the switch SW0 is connected to the third column output CLM3, the terminal “b” of the switch SW1 is connected to the fourth column output CLM4, the terminal “b” of the switch SW2 is connected to the fifth column output CLM5, and the terminal “b” of the switch SW3 is connected to the sixth column output CLM6. In the shuffle encoder 71-3, the switches SW0 to SW3 are switched at random and either of the signals of the column outputs CLM3 to CLM6 of the pixel portion 20 is input to the column signal processing circuit 51-3 in the third column.

In the shuffle encoder 71-4, the terminals “a” of the switches SW0 to SW3 are connected to the input of the column signal processing circuit 51-4 arranged in the fourth column. The terminal “b” of the switch SW0 is connected to the fourth column output CLM4, the terminal “b” of the switch SW1 is connected to the fifth column output CLM5, the terminal “b” of the switch SW2 is connected to the sixth column output CLM6, and the terminal “b” of the switch SW3 is connected to the seventh column output CLM7. In the shuffle encoder 71-4, the switches SW0 to SW3 are switched at random and either of the signals of the column outputs CLM4 to CLM7 of the pixel portion 20 is input to the column signal processing circuit 51-4 in the fourth column.

In the shuffle encoder 71-5, the terminals “a” of the switches SW0 to SW3 are connected to the input of the column signal processing circuit 51-5 arranged in the fifth column. The terminal “b” of the switch SW0 is connected to the fifth column output CLM5, the terminal “b” of the switch SW1 is connected to the sixth column output CLM6, the terminal “b” of the switch SW2 is connected to the seventh column output CLM7, and the terminal “b” of the switch SW3 is connected to the eighth column output CLM8 (not shown). In the shuffle encoder 71-5, the switches SW0 to SW3 are switched at random and either of the signals of the column outputs CLM5 to CLM8 of the pixel portion 20 is input to the column signal processing circuit 51-5 in the fifth column.

In the shuffle encoder 71-6, the terminals “a” of the switches SW0 to SW3 are connected to the input of the column signal processing circuit 51-6 arranged in the sixth column. The terminal “b” of the switch SW0 is connected to the sixth column output CLM6, the terminal “b” of the switch SW1 is connected to the seventh column output CLM7, the terminal “b” of the switch SW2 is connected to the eighth column output CLM8 (not shown), and the terminal “b” of the switch SW3 is connected to the ninth column output CLM9 (not shown). In the shuffle encoder 71-6, the switches SW0 to SW3 are switched at random and either of the signals of the column outputs CLM6 to CLM9 of the pixel portion 20 is input to the column signal processing circuit 51-6 in the sixth column.

In the shuffle encoder 71-7, the terminals “a” of the switches SW0 to SW3 are connected to the input of the column signal processing circuit 51-7 arranged in the seventh column. The terminal “b” of the switch SW0 is connected to the seventh column output CLM7, the terminal “b” of the switch SW1 is connected to the eighth column output CLM8 (not shown), the terminal “b” of the switch SW2 is connected to the ninth column output CLM9 (not shown), and the terminal “b” of the switch SW3 is connected to the tenth column output CLM10 (not shown). In the shuffle encoder 71-7, the switches SW0 to SW3 are switched at random and either of the signals of the column outputs CLM7 to CLM10 of the pixel portion 20 is input to the column signal processing circuit 51-7 in the seventh column.

In the shuffle decoder 81-0, the terminals “ID” of the switches SW10 to SW13 are connected to the output of the column signal processing circuit 51-0 arranged in the 0-th column. The terminal “a” of the switch SW10 is connected to the 0-th column output line OUT0, the terminal “a” of the switch SW11 is connected to the first column output line OUT1, the terminal “a” of the switch SW12 is connected to the second column output line OUT2, and the terminal “a” of the switch SW13 is connected to the third column output line OUTS. In the shuffle decoder 81-0, the switches SW10 to SW13 are switched at random and the output of the column signal processing circuit 51-0 in the 0-th column is output to either of the column output lines OUT0 to OUT3.

In the shuffle decoder 81-1, the terminals “b” of the switches SW10 to SW13 are connected to the output of the column signal processing circuit 51-1 arranged in the first column. The terminal “a” of the switch SW10 is connected to the first column output line OUT1, the terminal “a” of the switch SW11 is connected to the second column output line OUT2, the terminal “a” of the switch SW12 is connected to the third column output line OUT3, and the terminal “a” of the switch SW13 is connected to the fourth column output line OUT4. In the shuffle decoder 81-1, the switches SW10 to SW13 are switched at random and the output of the column signal processing circuit 51-1 in the first column is output to either of the column output lines OUT1 to OUT4.

In the shuffle decoder 81-2, the terminals “b” of the switches SW10 to SW13 are connected to the output of the column signal processing circuit 51-2 arranged in the second column. The terminal “a” of the switch SW10 is connected to the second column output line OUT2, the terminal “a” of the switch SW11 is connected to the third column output line OUT3, the terminal “a” of the switch SW12 is connected to the fourth column output line OUT4, and the terminal “a” of the switch SW13 is connected to the fifth column output line OUT5. In the shuffle decoder 81-2, the switches SW10 to SW13 are switched at random and the output of the column signal processing circuit 51-2 in the second column is output to either of the column output lines OUT2 to OUT5.

In the shuffle decoder 81-3, the terminals “b” of the switches SW10 to SW13 are connected to the output of the column signal processing circuit 51-3 arranged in the third column. The terminal “a” of the switch SW10 is connected to the third column output line OUT3, the terminal “a” of the switch SW11 is connected to the fourth column output line OUT4, the terminal “a” of the switch SW12 is connected to the fifth column output line OUT5, and the terminal “a” of the switch SW13 is connected to the sixth column output line OUT6. In the shuffle decoder 81-3, the switches SW10 to SW13 are switched at random and the output of the column signal processing circuit 51-3 in the third column is output to either of the column output lines OUT3 to OUT6.

In the shuffle decoder 81-4, the terminals “b” of the switches SW10 to SW13 are connected to the output of the column signal processing circuit 51-4 arranged in the fourth column. The terminal “a” of the switch SW10 is connected to the fourth column output line OUT4, the terminal “a” of the switch SW11 is connected to the fifth column output line OUT5, the terminal “a” of the switch SW12 is connected to the sixth column output line OUT6, and the terminal “a” of the switch SW13 is connected to the seventh column output line OUT7. In the shuffle decoder 81-4, the switches SW10 to SW13 are switched at random and the output of the column signal processing circuit 51-4 in the fourth column is output to either of the column output lines OUT4 to OUT7.

In the shuffle decoder 81-5, the terminals “b” of the switches SW10 to SW13 are connected to the output of the column signal processing circuit 51-5 arranged in the fifth column. The terminal “a” of the switch SW10 is connected to the fifth column output line OUTS, the terminal “a” of the switch SW11 is connected to the sixth column output line OUT6, the terminal “a” of the switch SW12 is connected to the seventh column output line OUT7, and the terminal “a” of the switch SW13 is connected to the eighth column output line OUT5 (not shown). In the shuffle decoder 81-5, the switches SW10 to SW13 are switched at random and the output of the column signal processing circuit 51-5 in the fifth column is output to either of the column output lines OUT5 to OUT8.

In the shuffle decoder 81-6, the terminals “b” of the switches SW10 to SW13 are connected to the output of the column signal processing circuit 51-6 arranged in the sixth column. The terminal “a” of the switch SW10 is connected to the sixth column output line OUT6, the terminal “a” of the switch SW11 is connected to the seventh column output line OUT7, the terminal “a” of the switch SW12 is connected to the eighth column output line OUT8 (not shown), and the terminal “a” of the switch SW13 is connected to the ninth column output line OUT9 (not shown). In the shuffle decoder 81-6, the switches SW10 to SW13 are switched at random and the output of the column signal processing circuit 51-6 in the sixth column is output to either of the column output lines OUT6 to OUT9.

In the shuffle decoder 81-7, the terminals “b” of the switches SW10 to SW13 are connected to the output of the column signal processing circuit 51-7 arranged in the seventh column. The terminal “a” of the switch SW10 is connected to the seventh column output line OUT7, the terminal “a” of the switch SW11 is connected to the eighth column output line OUT8 (not shown), the terminal “a” of the switch SW12 is connected to the ninth column output line OUTS (not shown), and the terminal “a” of the switch SW13 is connected to the 10th column output line OUT10 (not shown). In the shuffle decoder 81-7, the switches SW10 to SW13 are switched at random and the output of the column signal processing circuit 51-7 in the seventh column is output to either of the column output lines OUT7 to OUT10.

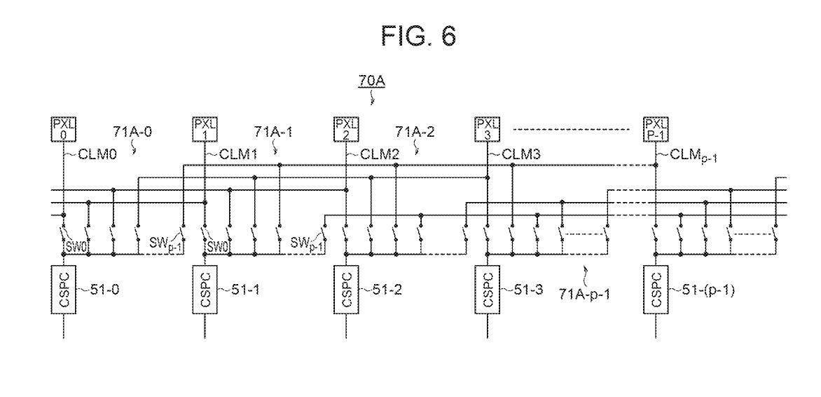

Note that, in the above explanation, the case where the number of the column outputs to be grouped together is four was explained as an example. However, the present invention is not limited to four. The number may be “p” of 3 or 5 or more as well. FIG. 6 is a diagram showing as a generalization an example of the configuration of the shuffle encoders in the first multiplexer array when the number of the column outputs to be grouped together is “p”.

In this case, each of the shuffle encoders 71A-0 to 71A-5 . . . in a first multiplexer array 70A is configured so as to include “p” number of on/off switches SW0 to SWp-1 since there are “p” number, larger than four, of column outputs grouped together. The shuffle decoders have the same configuration. This configuration is a generalization of the configuration in FIG. 5. Basically the configuration and functions are the same as those explained with reference to FIG. 5, therefore a detailed explanation thereof will be omitted.

In the solid-state imaging device 10 having the above configuration, the readout operation is schematically carried out as follows.

Under the control of the timing control circuit 40, in the pixel portion 20 having a plurality of pixels PXL for performing photoelectric conversion arranged in a matrix state therein, the pixel signals in the row designated by the vertical scanning circuit 30 are output as the column outputs CLM0 to CLMn to the column direction simultaneously in parallel. The signals of the column outputs CLM0 to CLMn of the pixel portion 20 are input to the first multiplexer array 70.

In the first multiplexer array 70, according to the instruction of the first control signal CTL41 by the timing control circuit 40, the destinations of the column output signals of the column outputs CLM0 to CLMm of the pixel portion 20 are shuffled and are switched so that they are input to the column signal processing circuit 51 in the readout circuit 50 which is arranged corresponding to the column output or to the column signal processing circuit 51 which is different from the column signal processing circuit arranged corresponding to the column output. In the first multiplexer array 70, the plurality of column outputs of the pixel portion 20 are formed in a plurality of groups, and the plurality of column outputs belonging to the groups are shuffled in the shuffle encoders 71 corresponding to the groups. Further, in the first multiplexer array 70, between the adjoining shuffle encoders, one or more column outputs are made to overlap for shuffling. The shuffle operation is carried out including the column outputs made to overlap.

The output signals of the column outputs shuffled in the first multiplexer array 70 are input to the column signal processing circuit 51 of the destination of shuffling in the readout circuit 50. In each column signal processing circuit 51 in the readout circuit 50, predetermined signal processing is carried out with respect to the column output signals supplied by the first multiplexer array 70, then the processed signals are input to the second multiplexer array 80.

In the second multiplexer array 80, according to the instruction of the second control signal CTL42 by the timing control circuit 40, the signals which are processed in each column signal processing circuit 51 in the readout circuit 50 are rearranged so as to become the sequence of column outputs CLM of the pixel portion 20 before shuffling in the first multiplexer array 70 and are supplied to the output circuit 60.

As explained above, in the present embodiment, as shown in FIG. 2 and FIG. 5, the first multiplexer array 70 is configured to include the plurality of shuffle encoders 71-0 to 71-7 . . . in which the plurality of column outputs CLM (0 to 10 . . . ) of the pixel portion 20 are formed into the plurality of groups GRP1a to 1d, GRP2a to 2d . . . and which can shuffle the plurality of column outputs CLM0 to 10 . . . belonging to the groups. Further, the adjoining shuffle encoders 71 are configured so that at least one column output, e.g., three column outputs in the example in FIG. 2, partially overlap as outputs covered by shuffling (covered by switching).

Below, the effects of the present embodiment in which the adjoining shuffle encoders 71 are configured so that at least one column output, e.g., three column outputs in the example in FIG. 2, partially overlap as outputs covered by shuffling (covered by switching) will be considered in comparison with a comparative example having a configuration where they are grouped together, but the outputs covered by switching are not made to overlap.

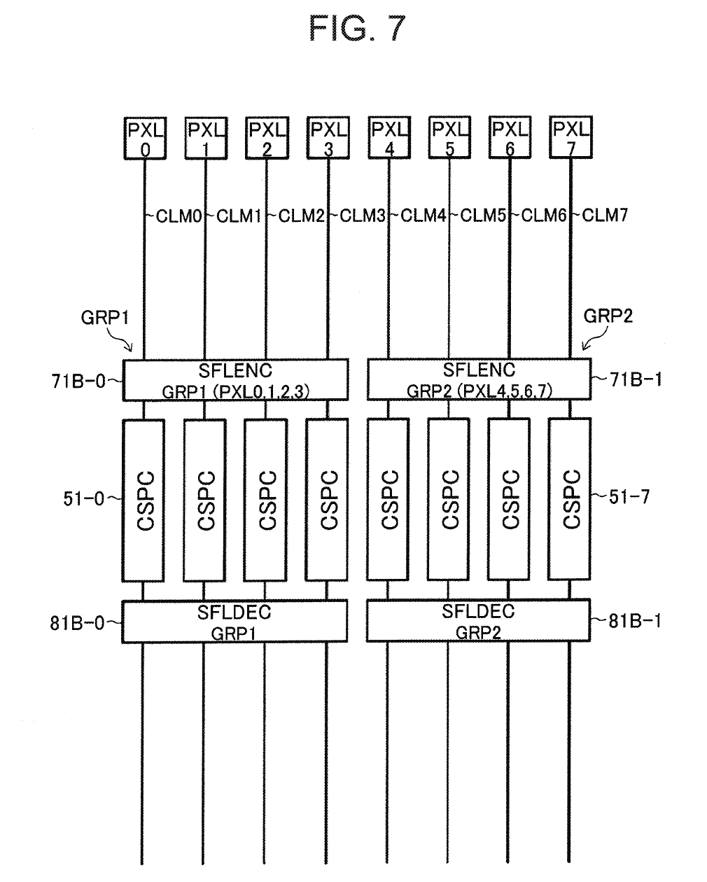

FIG. 7 is a diagram showing the configuration of the comparative example in which grouping is carried out, but the outputs covered by switching are not made to overlap. In FIG. 7, for facilitating understanding, the same portions as those in FIG. 2 will be represented by the same notations. In the example in FIG. 7, in a shuffle encoder 71B-0, only four column outputs CLM0 to CLM3 in the group GRP1 are covered by shuffling (covered by switching), while in a shuffle encoder 71B-1, only four column outputs CLM4 to CLM7 in the group GRP2 are covered by shuffling (covered by switching). Also, the shuffle decoders 81B-0 and 81B-1 have configurations according to the shuffle encoders 71B-0 and 71B-1.

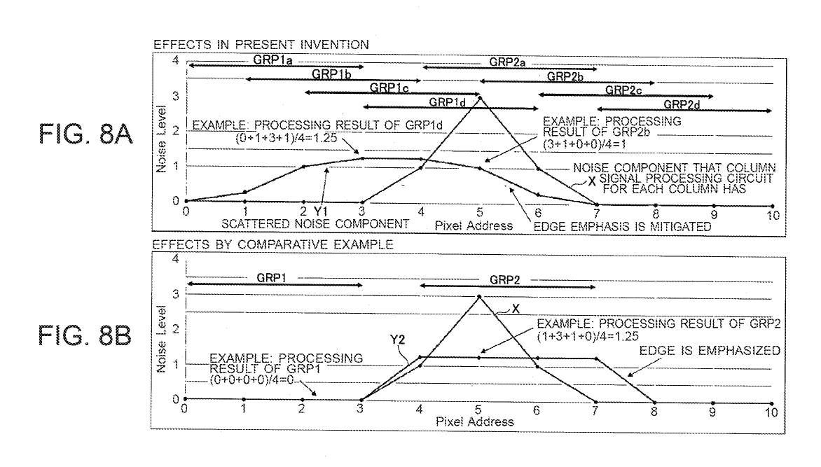

FIGS. 8A and 8B are diagrams for explaining the effects of the solid-state imaging device according to the present embodiment and the effects of the comparative example. FIG. 8A is a diagram for explaining the effects of the solid-state imaging device according to the present embodiment, and FIG. 8B is a diagram for explaining the effects of the comparative example. In FIGS. 8A and 8B, the abscissas show pixel addresses, and the ordinates show relative noise levels. Further, in FIGS. 8A and 8B, curves indicated by X show noise components that the column signal processing circuit for each column has, and curves indicated by Y1 and Y2 show noise components which are scattered.

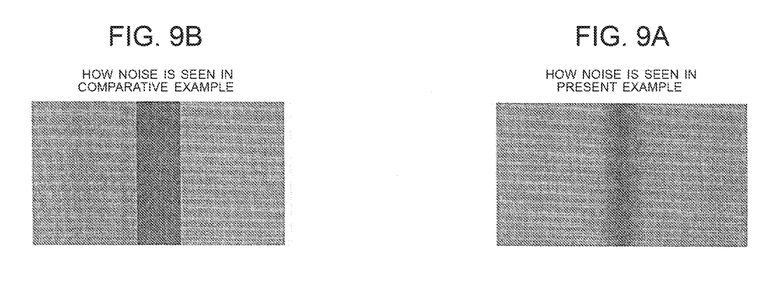

Further, FIG. 9 are diagrams showing how noises are viewed in the solid-state imaging device according to the present embodiment and in comparative example. FIG. 9A shows how noise is viewed in the solid-state imaging device according to the present embodiment, and FIG. 9B shows how noise is viewed in the comparative example.

In the solid-state imaging device 10 according to the present embodiment and comparative example, the noise that the column signal processing circuit 51 uniquely has for each column can be suppressed by scattering the same in time and space by switching (shuffling) the signal processing columns at random for each row.

In this regard, however, in the comparative example, any number of columns are grouped and to scatter the noise in time and space. Therefore, as shown in FIG. 8B, there is tendency that a difference of scattered noise levels between the adjoining groups is emphasized. As a result, in the comparative example, as shown in FIG. 9B, noise is distinctly and clearly visually recognized.

Contrary to this, in the solid-state imaging device 10 according to the present embodiment, the adjoining shuffle encoders 71 are configured so that at least one column output, for example, three column outputs, partially overlap as outputs covered by shuffling (covered by switching). Therefore, as shown in FIG. 8A, an effect of reduction of the difference of scattered noise levels between the groups adjacent to each other is obtained. As a result, in the solid-state imaging device 10 according to the present embodiment, as shown in FIG. 9A, noise blurs and is barely visually recognized in an unclear form, therefore the image quality can be improved.

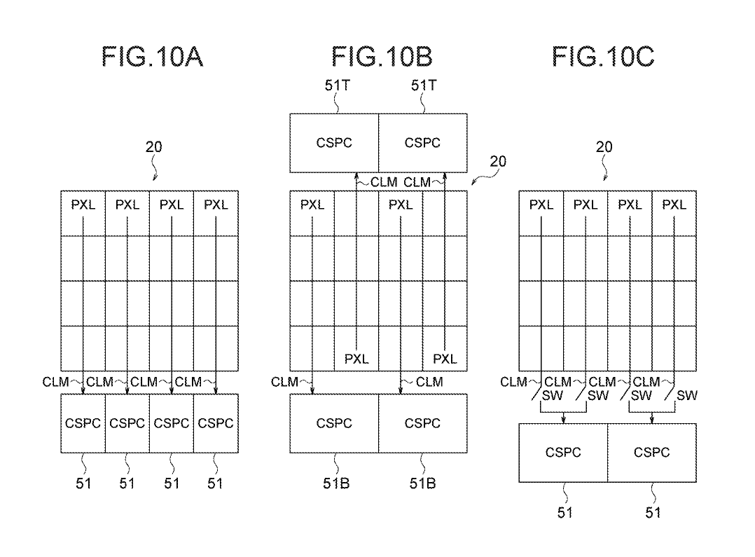

Note that, the embodiment explained above shows a configuration where, as an example, the column signal processing circuits 51 (-0 to -10 . . . ) in the readout circuit 50 are arranged as shown in FIG. 10A by the pixel pitch in a one-to-one correspondence with the column outputs CLM of the pixel portion 20. However, as explained above, the column signal processing circuits which are arranged corresponding to the column outputs referred to in the present invention are not limited to a configuration of arrangement with a one-to-one correspondence with the column outputs CLM. The “column signal processing circuits 51 arranged corresponding to the column outputs” mean column signal processing circuits which are arranged so that they can normally perform processing in the sequence of column arrangement on the column output signals of the column outputs of the sequence of column arrangement in the pixel portion 20. The arrangement positions and arrangement method are not specified.

FIGS. 10A to 10C are diagrams for explaining an example of arrangement focusing on the correspondence between the column outputs of pixels and the column signal processing circuits in the solid-state imaging device according to the embodiment of the present invention. Note that, in FIGS. 10A to 10C, in explaining in brief the example of arrangement focusing on the correspondence between the column outputs of pixels and the column signal processing circuits, for facilitating understanding, the first multiplexer array 70 etc. are omitted.

For example, as shown in FIG. 10A, other than the example of arrangement by the pixel pitch in a one-to-one correspondence, a case where they are arranged at 2 times, 4 times, or more times the above pixel pitch may be illustrated. For example, as shown in FIG. 10B, a case where column signal processing circuits 51T and 51B are arranged in upper and lower parts of the pixel portion (pixel array) 20 (the two end parts in the wiring direction of the vertical signal line) is exemplified. In this example, the column signal processing circuits are divided into the column signal processing circuits 51T and 51B in even number columns and odd number columns and are arranged above and below the pixel array.

Otherwise, as shown in FIG. 10C, a case of arranging one column signal processing circuit 51 for each two pixels, each four pixels, or more pixels is exemplified. Here, arranging one column signal processing circuit 51 for each two pixels, each four pixels, or more pixels means a configuration where one column signal processing circuit 51 is shared by a plurality of pixels so that it can take charge of and process the signals of two or four pixels. FIG. 10C shows a configuration in which the column signal processing circuit 51 is shared by two pixels, and switching is carried out by the switches SW.

Even if such configuration is employed, the same effects as the effects by the embodiment explained above can be obtained.

The solid-state imaging device 10 explained above can be applied as the imaging device to a digital camera, video camera, portable terminal, or monitoring camera, medical endoscope, or other electronic apparatus.

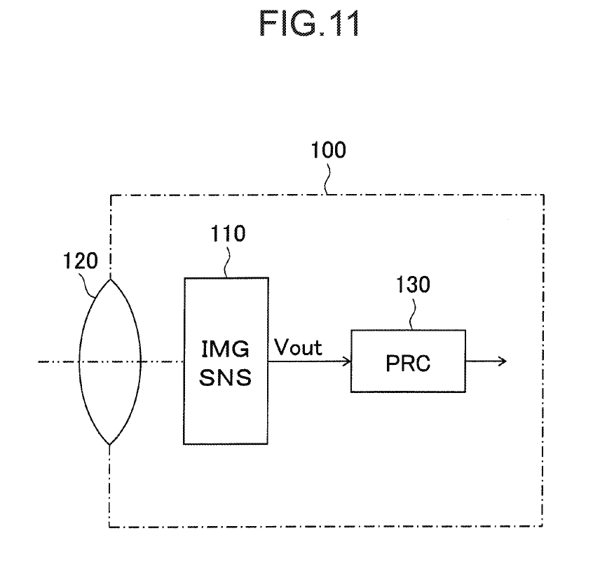

FIG. 11 is a diagram showing an example of the configuration of an electronic apparatus mounting a camera system to which the solid-state imaging device according to the embodiment of the present invention is applied.

The present electronic apparatus 100, as shown in FIG. 11, has a CMOS image sensor (IMGSNS) 110 to which the solid-state imaging device 10 according to the present embodiment can be applied Further, the electronic apparatus 100 has an optical system (lens etc.) 120 for guiding incident light (forming a subject image) into the pixel region in this CMOS image sensor 110. The electronic apparatus 100 has a signal processing circuit (PRC) 130 for processing the output signal of the CMOS image sensor 110.

The signal processing circuit 130 applies predetermined signal processing with respect to the output signal of the CMOS image sensor 110. The image signal processed in the signal processing circuit 130 can be projected as a moving image in a monitor configured by a liquid crystal display or the like or can be output to a printer. Further, for example, it may directly recorded in a memory card or other recording medium. Various forms are possible.

As explained above, by mounting the solid-state imaging device 10 explained before as the CMOS image sensor 110, it becomes possible to provide a high performance, small-size, and low cost camera system. Further, electronic apparatuses used for applications with restrictions due to the requirements of installation of cameras such as mounting size, number of connectable cables, cable lengths, and installation heights such as monitoring cameras, cameras for medical endoscopes, etc. can be realized.

1. A solid-state imaging device comprising
a pixel portion in which a plurality of pixels for performing photoelectric conversion are arranged in a matrix state,
a readout part which is arranged corresponding to at least one column output of the pixel portion and includes a plurality of column signal processing parts for processing the input column output signals,
an output part for outputting the signals processed in the plurality of column signal processing parts in the readout part,
a first multiplexer which shuffles destinations of the column output signals of the column outputs of the pixel portion and can switch them so as to input the results to column signal processing parts which are different from the column signal processing parts arranged corresponding to the column outputs, and
a second multiplexer which rearranges the signals processed in the plurality of column signal processing parts in the readout part so as to restore the sequence of the column outputs of the pixel portion before they were shuffled in the first multiplexer and supplies the results to the output part, wherein
the first multiplexer includes a plurality of shuffle encoders in which the plurality of column outputs of the pixel portion are formed into a plurality of groups and which can shuffle the plurality of column outputs belonging to the groups, and
at least between the adjoining shuffle encoders, there is at least one overlapping column output covered by shuffling.

2. The solid-state imaging device according to claim 1, wherein
the shuffle encoder switches at random destinations of the column output signals of the plurality of column outputs covered by shuffling which belong to the group and inputs the column output signal of the column output which is switched to either of the column signal processing parts which is arranged inside the group or outside of the group.

3. The solid-state imaging device according to claim 2, wherein
the shuffle encoder includes in the plurality of column outputs covered by shuffling belonging to the group, a reference column output capable of inputting a shuffled column output signal to a column signal processing part arranged corresponding to the column output in the group.

4. The solid-state imaging device according to claim 3, wherein
the shuffle encoder shuffles the reference column output and the column outputs other than the reference column output as outputs and inputs one shuffled column output signal to a column signal processing part arranged corresponding to any one column output in the group, and
at least one column output other than the reference column output becomes a reference of another shuffle encoder.

5. The solid-state imaging device according to claim 4, wherein
the shuffle encoder shuffles the reference column output of the group to which it belongs and a plurality of column outputs which are successively adjacent to the reference column output and inputs one shuffled column output signal to a column signal processing part arranged corresponding to any one column output in the group, and
one of the plurality of column outputs which are successively adjacent to the reference column output becomes a reference of another shuffle encoder.

6. The solid-state imaging device according to claim 4, wherein
the shuffle encoder shuffles the reference column output of the group to which it belongs and a plurality of column outputs which are successively adjacent to the reference column output and inputs one shuffled column output signal to a column signal processing part arranged corresponding to the reference column output, and
one of the plurality of column outputs which are successively adjacent to the reference column output becomes a reference of another shuffle encoder.

7. The solid-state imaging device according to claim 6, wherein
the adjacent column output among the plurality of column outputs which are successively adjacent to the reference column output is the reference column output of the adjacent shuffle encoder.

8. The solid-state imaging device according to claim 1, wherein
the second multiplexer includes a plurality of shuffle decoders which are arranged corresponding to the plurality of shuffle encoders in the first multiplexer, rearrange the signals processed in the plurality of column signal processing parts in the readout part so as to restore the sequence of column outputs of the pixel portion before they are shuffled in the shuffle encoders in the first multiplexer, and supply the results to the output part.

9. The solid-state imaging device according to claim 1, further comprising
a control part which controls the first multiplexer so as to shuffle the column outputs of the pixel portion and input the results at random to column signal processing parts which are different from the column signal processing parts arranged corresponding to the column outputs and controls the second multiplexer so as to rearrange the signals processed in the plurality of column signal processing parts in the readout part so as to restore the sequence of the column outputs of the pixel portion before they are shuffled in the first multiplexer and supply the results to the output part.

10. The solid-state imaging device according to claim 1, wherein
the column signal processing parts in the readout part include at least analog-to-digital converters (ADC) which convert analog signals to digital signals.

11. A method for driving a solid-state imaging device comprising
a column output step of simultaneously and in parallel outputting pixel signals in a designated row in a pixel portion having a plurality of pixels for performing photoelectric conversion arranged in a matrix state therein,
a first shuffle step of shuffling destinations of the column output signals of the column outputs of the pixel portion and capable of switching them so as to input the results to column signal processing parts which are different from the column signal processing parts arranged corresponding to the column outputs,
a column signal processing step of performing predetermined signal processing in the plurality of column signal processing parts on the column output signals supplied by the first shuffle step, and
a second shuffle step of rearranging the signals which are processed in the column signal processing step so as to restore the sequence of the column outputs of the pixel portion before they were shuffled in the first shuffle step and outputting the results to the output part, wherein,
in the first shuffle step, the plurality of column outputs of the pixel portion are formed into a plurality of groups, the plurality of column outputs belonging to the groups are shuffled in the shuffle encoders corresponding to the groups, and between at least the adjoining shuffle encoders, there is at least one overlapping column output covered by shuffling.

12. The method for driving a solid-state imaging device according to claim 11, wherein
in the shuffle encoder, the destinations of the column output signals of the plurality of column outputs as outputs covered by shuffling belonging to the group are switched at random and the column output signal of the column output which is switched is input to either of the column signal processing parts which is arranged inside the group or outside of the group.

13. The method for driving a solid-state imaging device according to claim 12, wherein
in the shuffle encoder,
the plurality of column outputs covered by shuffling belonging to the group include, in the group, a reference column output capable of inputting the shuffled column output signal to a column signal processing part arranged corresponding to the column output.

14. The method for driving a solid-state imaging device according to claim 13, wherein
in the shuffle encoder,
the reference column output and the other column outputs other than the reference column output are shuffled and one shuffled column output signal is input to a column signal processing part arranged corresponding to any one column output in the group, and
at least one column output other than the reference column output becomes a reference of another shuffle encoder.

15. The method for driving a solid-state imaging device according to claim 14, wherein
in the shuffle encoder,
the reference column output of the group to which it belongs and a plurality of column outputs which are successively adjacent to the reference column output are shuffled and one shuffled column output signal is input to a column signal processing part arranged corresponding to any one column output in the group, and
one of the plurality of column outputs which are successively adjacent to the reference column output becomes a reference of another shuffle encoder.

16. The method for driving a solid-state imaging device according to claim 14, wherein:
in the shuffle encoder,
the reference column output of the group to which it belongs and a plurality of column outputs which are successively adjacent to the reference column output are shuffled and one shuffled column output signal is input to a column signal processing part arranged corresponding to the reference column output, and
one of the plurality of column outputs which are successively adjacent to the reference column output becomes the reference of another shuffle encoder.

17. The method for driving a solid-state imaging device according to claim 16, wherein
the adjacent column output among the plurality of column outputs which are successively adjacent to the reference column output is the reference column output of the adjacent shuffle encoder.

18. An electronic apparatus comprising
a solid-state imaging device,
an optical system for forming a subject image in the solid-state imaging device, and
a signal processing part for processing output signals of the solid-state imaging device, wherein
the solid-state imaging device has
a pixel portion in which a plurality of pixels for performing photoelectric conversion are arranged in a matrix state,
a readout part which is arranged corresponding to at least one column output of the pixel portion and includes a plurality of column signal processing parts for processing the input column output signals,
an output part for outputting the signals processed in the plurality of column signal processing parts in the readout part,
a first multiplexer which shuffles destinations of the column output signals of the column outputs of the pixel portion and can switch them so as to input results to column signal processing parts which are different from the column signal processing parts arranged corresponding to the column outputs, and
a second multiplexer which rearranges the signals processed in the plurality of column signal processing parts in the readout part so as to restore the sequence of the column outputs of the pixel portion before they were shuffled in the first multiplexer and supplies the results to the output part, wherein
the first multiplexer including a plurality of shuffle encoders in which the plurality of column outputs of the pixel portion are formed into a plurality of groups and which can shuffle the plurality of column outputs belonging to the groups, and
at least between the adjoining shuffle encoders, there is at least one overlapping column output covered by shuffling.
